(19) United States
(12) Patent Application Publication
(10) Pub. No.: US 2013/0002831 A1
(43) Pub. Date: Jan. 3, 2013

(54) Infrared Emitter in Projection Display Television

(75) Inventors: Charles Davis, Trabuco Canyon, CA (US); Masafumi Naka, Irvine, CA (US)

(73) Assignee: Mitsubishi Electric Visual Solutions America, Inc.

(21) Appl. No.: 13/285,190

(22) Filed: Oct. 31, 2011

Related U.S. Application Data
(60) Provisional application No. 61/502,484, filed on Jun. 29, 2011.

(51) Int. Cl. H04N 9/31; H04N 13/04

(52) U.S. Cl. 348/51; 348/744; 348/E09.025; 348/E13.026

(57) ABSTRACT

An IR emitter internally mounted behind the screen of a projection television apparatus. The IR emitter is mounted so as not to interfere with the image display light path. The IR emitter is mounted so that IR rays are reflected off the mirror and exit through the screen of the projection television. The IR emitter includes one or more IR type LEDs.

### CROSS-REFERENCE TO RELATED APPLICATIONS

This application claims priority to U.S. provisional patent application, Ser. No. 61/502,484, filed Jun. 29, 2011. Priority to the provisional patent application is expressly claimed, and the disclosure of the provisional application is hereby incorporated herein by reference in its entirety and for all purposes.

### FIELD

The embodiments provided herein relate generally to projection television systems and infrared emitters coupled thereto and more particularly to systems and methods for an infrared emitter positioned internal to the projection television system.

### BACKGROUND INFORMATION

Television receiver sets now available in the commercial market, including those of the projection type, have infrared (IR) emitters typically in the form of laser emitting diodes (LEDs) arrays, for generating an infrared beam or beams of a particular characteristic descriptive of a particular command to control IR controllable devices such as, for example, 3D shutter glasses. The IR emitter typically projects from a window on the front cosmetic panel of the television.

To improve the coverage area of the IR emitter, the number of LEDs in the array would need to be increased. This negatively impacts the cost and the cosmetic appearance of the television.

Accordingly, it would be desirable to provide an IR emitter with improved coverage area without increasing the complexity and cost of the system, or negatively impacting the cosmetic design of the television.

### SUMMARY

The systems and methods described herein provide for mounting an IR emitter, for example a single IR type LED or an array of IR type LEDs, behind the screen of a projection television apparatus. The LED is mounted so as not to interfere with the image display light path from the projection engine. The LED is mounted so that IR rays are reflected off the reflector mirror and exit through the screen of the projection television.

Other systems, methods, features and advantages of the invention will be or will become apparent to one with skill in the art upon examination of the following figures and detailed description.

### BRIEF DESCRIPTION OF THE FIGURES

The details of the invention, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 depicts a side view of a projection television (PTV) with an internally positioned IR emitter with IR signals projected out to devices to be controlled.

FIG. 2 depicts a schematic of an embodiment of a control system.

FIG. 3 depicts a schematic of another embodiment of a control system.

### DETAILED DESCRIPTION

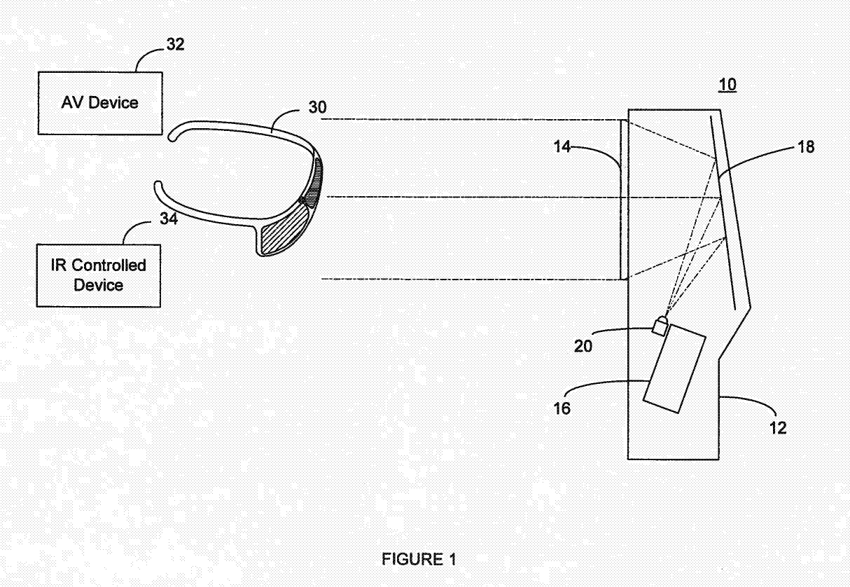

The systems and methods described herein provide for mounting an IR emitter, for example a single IR type LED or an array of IR type LEDs, behind the screen of a projection television apparatus. The LED is mounted so as not to interfere with the image display light path from the projection engine. The LED is mounted so that IR rays are reflected off the reflector mirror and exit through the screen of the projection television turning in detail to the figures, FIG. 1 depicts a projection television (PTV) 10 comprising a cabinet or enclosure 12, an image projection engine or system 16, e.g., a DLP, LCD or LCOS based projection engine or the like, a projection screen assembly 14 attached to the front of the cabinet 12, and a reflector mirror 18 mounted in the interior of the cabinet 12 and optically coupled to the projection screen assembly 14 and the image projection engine 16.

Red, blue, and green pixels are projected by the respective image projection engine or system 16 onto the reflector mirror 18, which is supported in the rear wall of the cabinet 12, and then reflected by the reflector mirror 18 towards the rear projection screen 14 whereat the pixels of three primary colors are matched together to provide a color video picture. The color video picture projected onto the rear projection screen 14 can be viewed from the front of the cabinet 12 generally in a direction counter to the direction of travel of the imagewise rays of light reflected from the reflector mirror 18.

The rear projection screen 14 used in the practice of the present embodiment is of a type comprising either a single-layered structure or a double- or multi-layered structure including a Fresnel lens plate and a diffusing or lenticular lens plate. In the single-layered structure, the Fresnel lens plate and the diffusing or lenticular lens plate are formed on respective opposite surfaces of a single substrate. In the multi-layered structure, at least the Fresnel lens plate and the diffusing or lenticular lens plate separate from the Fresnel lens plate are sandwiched or integrated together. In either case, therefore, the rear projection screen 14 can exhibit an effect or characteristic similar to an optical lens element.

As depicted in FIG. 1, an IR emitter 20 is mounted behind the rear projection screen 14 of the projection television 10. The IR emitter 20 preferably comprises a one or more LEDs, wherein a plurality of LEDs is preferably arranged in an array. The LED of the IR emitter 20 is mounted so as not to interfere with the image display light path of the image engine 16. The LED of the IR emitter 20 is mounted so that IR rays of light are reflected off the reflector mirror 18 and exit through the rear projection screen 14 of the projection television 10. As shown, the IR emitter 20 can be used to control 3D shutter glasses 30, an AV device 32, or other IR controllable devices 34.

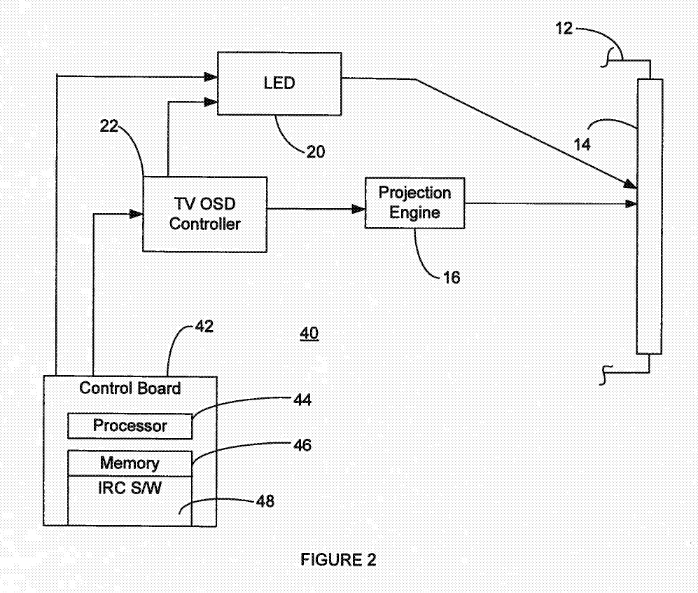

Referring to FIG. 2, in one embodiment the television includes a control system 40 that comprises programmable logic depicted as a control board 42. The control board 42 is coupled to the LED 20 and the television's on screen display (OSD) controller 22, which is also coupled to the LED 20. The OSD controller 22 is coupled to the television's projection engine 16. Both the projection engine 16 and the LED 20 are optically coupled to the screen 14.

The control board 42 preferably comprises a microprocessor chip 44, non-volatile memory 46 and software 48 stored in the memory 46. The software 48 includes a set of instructions used to control the LED 20 and to incorporate particular commands in the IR signals to be projected onto the reflector mirror 18 and out through the screen 14.

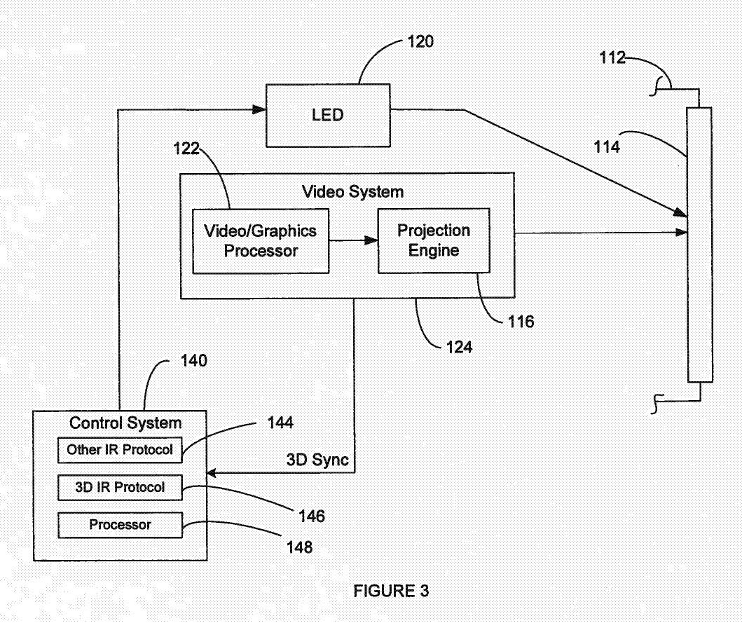

In another embodiment depicted in FIG. 3, a control system 140 includes a processor 148, a 3D IR protocol module 146, an IR protocol module 144 for other IR protocol and software executable on the processor 148. The control system 140 is coupled to the LED 20 and the video system 124, which comprises a video/graphics processor 122 coupled to the projection engine 116. The video system 124 and the LED 120 are both are optically coupled to the screen 114. In operation, the control system 140 is shown to receive a 3D sync signal from the video system 140 to sync the IR control with the video image.

In operation, as depicted in FIG. 1, the IR emitter 20 projects IR light signals onto the mirror 18. The mirror 18 reflects the IR light signals towards the display screen 14, which acts as a lens passing the IR light signals through to control IR controllable devices in the area beyond the screen 14.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A projection television apparatus comprising
an enclosure,
a display screen mounted on the enclosure,
a reflector mirror positioned within the enclosure and optically coupled to the display screen,
an image projection engine positioned within the enclosure and optically coupled to the reflector mirror, and
an infrared emitter positioned within the enclosure and optically coupled to the reflector mirror, wherein infrared light signals emitted from the infrared emitter are reflected off the reflector mirror and exit through the display screen.

2. The projection television of claim 1 wherein the light path of the infrared light signals emitted from the infrared emitter between the infrared emitter to the reflector mirror does not interfere with an image display light path of light emitted from the image projection engine.

3. The projection television of claim 1 wherein the infrared emitter includes a plurality of laser emitting diodes (LEDs).

4. The projection television of claim 3 wherein the LEDs are arranged in an array.

5. The projection television of claim 1 wherein the infrared emitter includes a one or more laser emitting diodes (LEDs).

6. The projection television of claim 1 further comprising a video/graphics processor coupled to the image projection engine.

7. The projection television of claim 6 further comprising a control system coupled to the video/graphics processor and the infrared emitter.

8. The projection television of claim 7 wherein the control system includes a processor and IR protocol module.

9. The projection television of claim 8 wherein the control system further includes a 3D IR protocol module.
